(19) United States
(12) Patent Application Publication
(10) Pub. No.: US 2014/0214586 A1
(43) Pub. Date: Jul. 31, 2014

(54) PROVIDING CONFIGURATION RECOMMENDATIONS AS PART OF A SALES PROCESS

(71) Applicants: Ulrike Muench, Bruchsal (DE); Nadim Razvi, Speyer (DE); Marco Sachs, St. Leon-Rot (DE)

(72) Inventors: Ulrike Muench, Bruchsal (DE); Nadim Razvi, Speyer (DE); Marco Sachs, St. Leon-Rot (DE)

(73) Assignee: SAP AG, Walldorf (DE)

(21) Appl. No.: 13/754,677

(22) Filed: Jan. 30, 2013

(51) Int. Cl. G06Q 30/06

(52) U.S. Cl. CPC G06Q 30/0631
USPC 705/26.5; 705/26.7

(57) ABSTRACT

The present disclosure describes methods, systems, and computer program products for providing configuration recommendations as part of a sales process. One computer-implemented method includes determining that a general recommendation engine (GRE) is available to make a GRE configuration recommendation for a selected software application, generating, by operation of a computer, the GRE configuration recommendation for the selected software application based upon GRE-applicable recommendation data and recommendation rules, determining that a private recommendation engine (PRE) is available to make a PRE configuration recommendation for the selected software application, determining that the PRE is permitted to make the PRE configuration recommendation based upon analyzed coordination rules, and generating, by operation of a computer, the PRE configuration recommendation for the selected software application based upon PRE-applicable recommendation data and recommendation rules.

### BACKGROUND

The present disclosure relates to computer-implemented methods, computer-readable media, and computer systems for providing configuration recommendations as part of a sales process. Some buyers may directly purchase software applications off the shelves or online, and install the purchased software applications on a computer with little or no further customization. Certain software applications, however, are purchased by sophisticated buyers that desire the ability to customize the software applications prior to purchase in order to meet specific requirements. Current configuration systems usually present a buyer with selectable available configuration options used to configure the software application but fail to provide configuration recommendations for the software application throughout the sales process. This inability to provide configuration recommendations is a lost opportunity to influence the configuration of a purchased software application, increase overall revenue associated with the sale of the software application, offer additional configuration options, and ensure the needs of the buyer are met by the purchased software application.

### SUMMARY

The present disclosure relates to computer-implemented methods, computer-readable media, and computer systems for providing configuration recommendations as part of a sales process. One computer-implemented method includes determining that a general recommendation engine (GRE) is available to make a GRE configuration recommendation for a selected software application, generating, by operation of a computer, the GRE configuration recommendation for the selected software application based upon GRE-applicable recommendation data and recommendation rules, determining that a private recommendation engine (PRE) is available to make a PRE configuration recommendation for the selected software application, determining that the PRE is permitted to make the PRE configuration recommendation based upon analyzed coordination rules, and generating, by operation of a computer, the PRE configuration recommendation for the selected software application based upon PRE-applicable recommendation data and recommendation rules.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the software application is selected by a buyer to be configured with respect to optional software application configuration options.

A second aspect, combinable with any of the previous aspects, further comprising determining a configuration complexity level for the software application.

A third aspect, combinable with any of the previous aspects, wherein at least one of a GRE recommendation complexity or a PRE recommendation complexity is based upon the configuration complexity level.

A fourth aspect, combinable with any of the previous aspects, further comprising determining a configuration process stage associated with a configuration sales process associated with the selected software application.

A fifth aspect, combinable with any of the previous aspects, further comprising: accessing the GRE-applicable recommendation data and recommendation rules and analyzing the GRE-applicable recommendation data and recommendation rules.

A sixth aspect, combinable with any of the previous aspects, further comprising: accessing the coordination rules and analyzing the coordination rules.

A seventh aspect, combinable with any of the previous aspects, further comprising: accessing the PRE-applicable recommendation data and recommendation rules and analyzing the PRE-applicable recommendation data and recommendation rules.

The subject matter described in this specification can be implemented in particular implementations so as to realize one or more of the following advantages. First, additional configuration options provided by a third-party solution partner can be made available for a software application that would not normally be provided by a solution provider. Second, the additional configuration options can enhance the functionality of the software application as well as increasing revenue though the sale of the additional configuration options. Third, the configuration of the purchased software application can be influenced to both increase revenue and enhance the functionality of the software application. Fourth, the buyer of the software application can be provided is presented with an efficient and easy-to-use software purchasing platform coupled with a more personalized/tailored software purchasing experience which may increase customer loyalty and repeat purchases. Fifth, the known/projected needs of the buyer can be met to help ensure the satisfaction of the buyer. Sixth, leveraging known technology of the solution provider allows for consistency and a shorter implementation cycle to provide varied and up-to-date configuration recommendations to a consumer and/or maintain the configuration and/or recommendation environment. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1A is a block diagram illustrating an example distributed computing system for providing configuration recommendations as part of a sales process.

FIG. 1B is a block diagram illustrating configuration recommendation generation and display as part of a sales process according to one implementation.

FIG. 2 is a block diagram illustrating different complexity levels of a buying center store.

FIG. 3 is a block diagram illustrating scope of general versus private recommendations associated with a buying center store configuration process.

FIG. 4 is a flow chart illustrating a method for providing configuration recommendations as part of a sales process.

Like reference numbers and designations in the various drawings indicate like elements.

### DETAILED DESCRIPTION

This disclosure generally describes computer-implemented methods, computer-program products, and systems for providing configuration recommendations as part of a sales process.

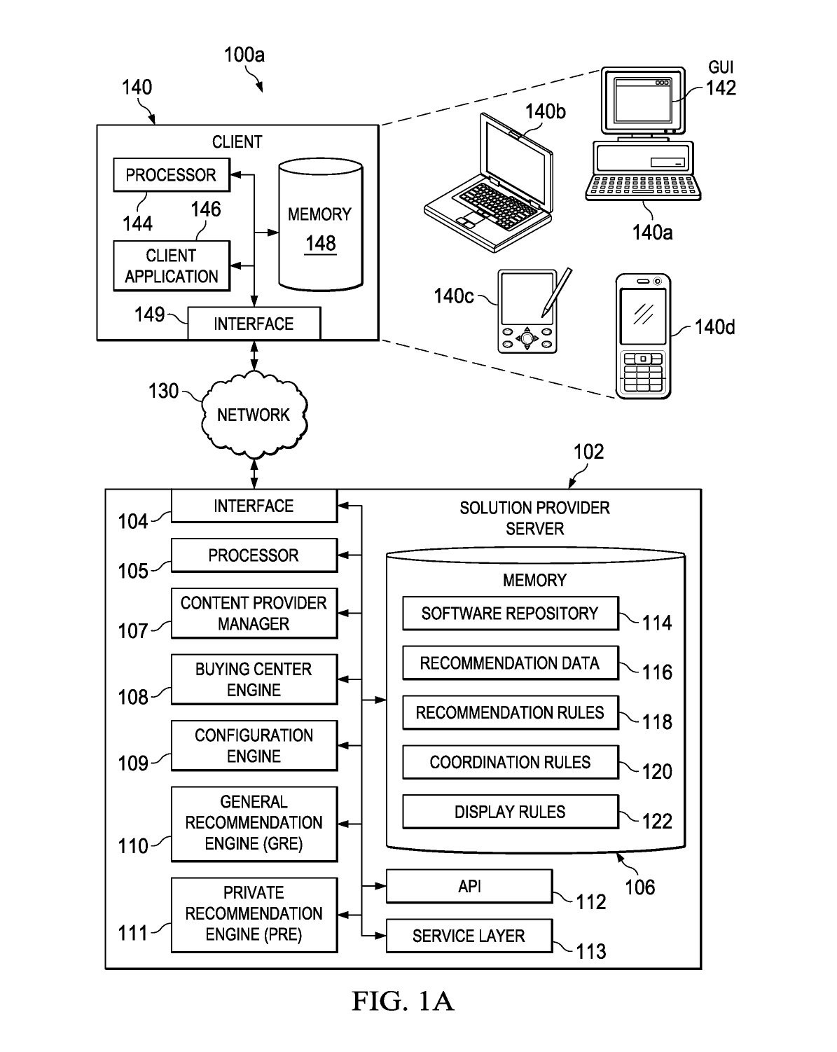

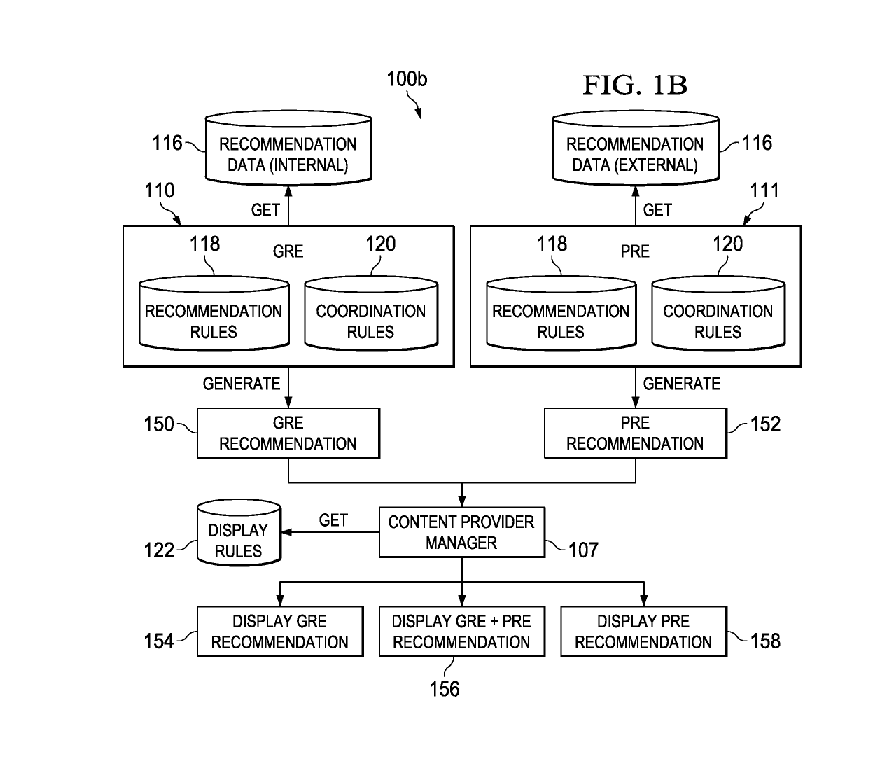

FIG. 1A is a block diagram illustrating an example distributed computing system 100 for providing configuration recommendations as part of a sales process. The illustrated example distributed computing system 100 includes or is communicably coupled with a solution provider server (SPS) 102 and a client 140 (solution partner/buyer) that communicate across a network 130 (described below). At a high level, the SPS 102 is an electronic computing device operable to receive, transmit, process, store, or manage data and information associated with the example distributed computing system 100. According to some implementations, SPS 102 may also include or be communicably coupled with an e-mail server, a web server, a caching server, a streaming data server, and/or other suitable server. The following described computer-implemented methods, computer-readable media, computer systems, and components of the example distributed computer system 100 provide functionality through one or more graphical user interfaces (GUIs) providing an efficient and user-friendly presentation of data provided by or communicated within the example distributed computing system 100.

The SPS 102 provides a buying center “store” application where a solution provider the ability to make one or more software applications available to a buyer and for the buyer to be able to search for, select, and/or configure the one or more software applications. Solution providers typically control the SPS and hosted data associated with the SPS 102 and determine rules/policies pertaining to the SPS 102 and its use by third parties and/or buyers.

In some implementations the SPS 102 can also make software application configuration option recommendations to the buyer in order to add and/or subtract certain available software application functionalities using a configuration engine and/or general recommendation engine (GRE) (described below). Solution providers can also configure and/or access data associated with a particular type of buyer and/or specific buyers to enhance the functionality/accuracy of the GRE.

To facilitate the provision of available software application configuration options, the solution provider may employ one or more third-party solution partners. In some implementations, the third-party solution partners can be certified by the solution provider as value-added service providers who may be a local representative of the solution provider and/or independent software application configuration option providers. In some implementations, solution partners are provided the ability to configure the GRE and/or a private recommendation engine (PRE) (a recommendation engine provided by a particular solution partner) in order to recommend solution-provider-allowed software application configuration options to the buyer which may or may not be contrary to the solution provider's recommendations. In some implementations, the solution partner can also configure and/or access data associated with a particular type of buyer and/or specific buyers to enhance the functionality of the GRE and/or the PRE. In some implementations, the solution partner may also be authorized to sell the software application at prices authorized by the solution provider and/or at prices determined by the solution partner.

The SPS 102 allows a buyer to search for, configure, and purchase software applications. Following a determination of data associated with the buyer and/or during the buyer's search for and/or configuration of a particular software application, the SPS 102 may present multiple recommendations of software application configuration options generated by the GRE, PRE, and/or other suitable component of the example distributed computing system 100.

The SPS 102 is responsible for receiving requests using the network 130, for example login requests, software selection, configuration, and/or purchase requests from one or more client applications 146 (described below) associated with the client 140 of the example distributed computing system 100 and responding to the received requests by processing said requests in one or more of a content provider manager 107 (described below), buying center engine 108 (described below), and/or GRE 111 (and in some implementations a PRE 111), and, in some implementations, sending the appropriate response from the content provider manager 107 back to the requesting client application 146. In addition to requests from the client 140, requests may also be sent to the SPS 102 from internal users, external or third-parties, other automated applications, as well as any other appropriate entities, individuals, systems, or computers.

In some implementations, requests/responses can be sent directly to SPS 102 from a user accessing SPS 102 directly. In some implementations, the SPS 102 may store a plurality of content provider managers 107, buying center engines 108, configuration engines 110, GREs 110 (and in some implementations PREs 111), and/or other components either illustrated or not illustrated. In some implementations, the SPS 102 may comprise a web server, where one or more of the components of SPS 102 represent web-based applications accessed and executed by the client 140 using the network 130 or directly at the SPS 102 to perform the programmed tasks or operations of the various components of SPS 102.

In some implementations, any and/or all components of the SPS 102, both hardware and/or software, may interface with each other and/or the interface using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the example distributed computing system 100. The functionality of the SPS 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the SPS 102 in the example distributed computing system 100, alternative implementations may illustrate the API 112 and/or the service layer 113 as stand-alone components in relation to other components of the example distributed computing system 100. Moreover, any or all parts of the API 112 and/or the service layer 113 may be implemented as child or sub-modules of another software module, enterprise application, or hardware module without departing from the scope of this disclosure.

The SPS 102 includes an interface 104. Although illustrated as a single interface 104 in FIG. 1, two or more interfaces 104 may be used according to particular needs, desires, or particular implementations of the example distributed computing system 100. The interface 104 is used by the SPS 102 for communicating with other systems in a distributed environment—including within the example distributed computing system 100—connected to the network 130; for example, the client 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The SPS 102 includes a processor 105. Although illustrated as a single processor 105 in FIG. 1, two or more processors may be used according to particular needs, desires, or particular implementations of the example distributed computing system 100. Generally, the processor 105 executes instructions and manipulates data to perform the operations of the SPS 102. Specifically, the processor 105 executes the functionality required to provide configuration recommendations as part of a sales process.

The SPS 102 also includes a memory 106 that holds data for the SPS 102, client 140, and/or other components of the example distributed computing system 102. Although illustrated as a single memory 106 in FIG. 1, two or more memories may be used according to particular needs, desires, or particular implementations of the example distributed computing system 100. While memory 106 is illustrated as an integral component of the SPS 102, in alternative implementations, memory 106 can be external to the SPS 102 and/or the example distributed computing system 100. In some implementations, the memory 106 includes one or more instances of a software repository 114, recommendation data 116, recommendation rules 118, and coordination rules 120.

The software repository 114 can be considered any suitable storage structure in any suitable form holding, wholly or partially, software applications and/or software application options. For example, the software repository 114 can be a database, a magnetic and/or optical library, a data structure, a networked resource, a flat file, a binary file, and/or other suitable data storage resource. Software applications can be any type of application, for example business applications, that may be configured with software application options.

The software repository 114 can also hold, wholly or partially, software application options. Software application options can include additional code, packages, executable files, binary files, flat files, database files, and/or other suitable data capable of being added to/removed from a particular software application that results in a software application with additional or less functionality, respectively.

In some implementations, the software repository 114 can be searched and/or provide search functionality. In some implementations, the software repository 114 can supply data responsive to a request from any suitable component of the example distributed computing system 100, for example the client 140. In some implementations, the software repository 114 can proactively push data to any suitable component of the example distributed computing system 100. In some implementations, the software repository 114 can act as a reference to an external storage location and/or provide functionality to retrieve a requested software application and/or software application options from the external storage location.

The recommendation data 116 is any type of data associated with a solution provider, solution partner, and/or buyer used to identify, classify, specify needs of, specify necessary configuration complexity level for specific software applications, and/or permit access to the SPS 102. For example, the recommendation data may specify that a buyer “XYZ Corp.” is in the video conversion industry to provide video data for mobile devices, has annual sales of US $2 million dollars, 155 employees, and currently uses version 2.2 of an example MediaConversionPlus software application with known software application options to convert DVD/Blu-ray video data to formats for mobile devices. The configuration complexity level may also be indicated as medium level, thus requiring only minor configuration option recommendations.

In some implementations, recommendation data 116 may be provided by the solution provider, the solution partners, the buyers and/or obtained independently. For example, the example data pertaining to the XYZ Corp. in the recommendation data 116 may have been wholly or partially provided by XYZ Corp. as an existing customer of the solution provider/solution partner in order to establish an account and/or profile. The recommendation data could also be obtained from an information broker/information gathering mechanism. For example, a “crawler,” “spider,” “bot,” and/or other traversal application could have been used to crawl (traverse) paths of XYZ Corp's web page and industry related web pages to glean as much information as possible about XYZ Corp. and used software applications and/or software application options. This gathered data could then be put into the recommendation data 116 as internal recommendation data. Those of skill in the art will appreciate that these examples are representative only and recommendation data 116 could represent myriad forms and types of data gathered in numerous ways. The provided examples are not meant to be limiting in any way.

In some implementations, the recommendation data 116 can be stored and/or represented in any form, for example a database table, flat file, binary file, or other suitable file. In some implementations, the recommendation data 116 can be organized to aggregate similar data into groups, for example buyer types (e.g., video conversion industry), or into any suitable structure for any suitable reason, such as efficiency, storage reduction, and the like. In some implementations, the recommendation data 116 may be extrapolated based on patterns or trends detected in existing recommendation data 116 at any particular point in time. In some implementations, the recommendation data 116 can be modified by the SPS 102, client 140, and/or other suitable component of the example distributed computing system 102. In some implementations, the recommendation data 116 may also be used to store historical information pertaining to the solution provider, solution partners, and/or buyers.

While recommendation data 116 is illustrated as an integral component of the memory 106, in alternative implementations, recommendation data 116 can be external to the memory 106 and/or be separated into both internal recommendation data 116 and external recommendation data 116 as long as it is accessible using network 130. For example, solution providers can have stored internal recommendation data 116 associated with the SPS 102 which solution partners can have external recommendation data 116 visible to the GRE 110 and/or the PRE 111. In some implementations, the recommendation data 116 can act as a reference to an actual other internal and/or external storage location and/or provide functionality to retrieve recommendation data stored in the external storage location.

The recommendation rules 118 may represent policies, conditions, parameters, variables, algorithms, instructions, constraints, references, and any other appropriate information used by the buying center engine 108, configuration engine 109, and/or the GRE 111/PRE 111 to make a recommendation, for example, after login to the SPS during the searching, selection, and/or configuration of a software application, for a software application and/or software application options. In some implementations, the recommendation rules 118 are used to determine which recommendations are provided to an SPS 102 user, for example a buyer. For example, XYZ Corp. has logged into the buying center store. The solution provider's GRE 111 can access the recommendation data 116 for XYZ Corp. and, using applicable recommendation rules 118, recommend that XYZ Corp. update their version of the MediaConversionPlus software application to version 3.1. Given XYZ Corp.'s industry and changes in technology since XYZ Corp's purchase of version 2.2, one or more recommendation rules 118 can specify that XYZ Corp. should be asked whether to upgrade their older version of the software application as soon as they login to the buying center store.

In some implementations, recommendation rules 118 may be provided by the solution provider, the solution partners, and/or the buyers and/or obtained independently. For example, a particular buyer could specify that after their licensed software application has reached a certain age, the buying center store should recommend an upgrade upon the particular buyer's login to the buying center store. This desire could be stored as a recommendation rule 118 and be associated with the particular buyer. In another example, the recommendation rule could be generated by the solution provider and/or solution partner for any buyer in XYZ Corp's industry or be recommended by an outside industry group. In some implementations, the developer of the MediaConversionPlus software application could recommend a recommendation rule to apply to any user of the MediaConversionPlus software application to recommend an upgrade after a version of the software application reaches a particular age. Those of skill in the art will appreciate that these examples are representative only and recommendation rules 118 could represent numerous conditions and be generated in a myriad of possible ways and in response to any type of applicable data, etc. The provided examples are not meant to be limiting in any way.

In some implementations, the recommendation rules 118 can be stored and/or represented in any form, for example a database table, flat file, binary file, or other suitable file. In some implementations, the recommendation rules 118 can be organized to aggregate similar data into groups, for example responses to buyer actions, or into any suitable structure for any suitable reason, such as efficiency, storage reduction, and the like. In some implementations, the recommendation rules 118 may be extrapolated based on patterns or trends detected in existing recommendation rules 118 at any particular point in time. In some implementations, the recommendation rules 118 can be modified by the SPS 102, client 140, and/or other suitable component of the example distributed computing system 102. In some implementations, the recommendation rules 118 may also be used to store historical recommendation rule 118 information pertaining to the solution provider, solution partners, and/or buyers.

While recommendation rules 118 are illustrated as an integral component of the memory 106, in alternative implementations, recommendation rules 118 can be external to the memory 106, SPS 102, and/or the example distributed computing system 100 as long as it is accessible using network 130. In some implementations, the recommendation rules 118 can act as a reference to an external storage location and/or provide functionality to retrieve recommendation rules stored in the external storage location.

The coordination rules 120 may represent policies, conditions, parameters, variables, algorithms, instructions, constraints, references, and any other appropriate information used by the buying center engine 108, configuration engine 109, and/or the GRE 111/PRE 111 to coordinate between recommendations made by a particular GRE 111 and a particular PRE 111. For example, the SPS 102 (solution provider) GRE 111 may recommend to XYZ Corp. that the company upgrade its MediaConversionPlus software application version 2.2 to version 3.1, but a particular PRE 111 may recommend that XYZ Corp. update MediaConversionPlus to version 3.5 due to available features in version 3.5 that it has determined through recommendation data 116 and/or recommendation rules 118 would be advantageous to XYZ Corp. The coordination rules 120 are in place to determine whether a solution partner's PRE 111 is permitted to override a solution provider's GRE 111, whether both recommendations would be displayed to a buyer, and other suitable decisions. Factors taken into consideration by the coordination rules 120 could include a level of status of a solution partner, whether a royalty will be paid to the solution provider for the sale regardless of which recommendation a buyer takes, whether a fee has been paid to the solution provider to permit such overriding recommendations to be made, and the like.

In some implementations, coordination rules 120 may be provided by the solution provider, the solution partners, and/or the buyers. For example, a particular buyer could specify that they wish to always see alternate recommendations, regardless of the source. In another example, a solution provider may pay a fee for the “privilege” to offer competing recommendations to a buyer. In another example, the solution provider may specify that some competing recommendations are allowed to be presented to a buyer, while others are not. This may be, for example, to preserve a specific market for the solution provider. In some implementations, the coordination rules 120 may give priority to one solution partner over others for any suitable reason. Those of skill in the art will appreciate that these examples are representative only and coordination rules 120 could represent numerous conditions and factors in response to any type of applicable data, etc. The provided examples are not meant to be limiting in any way.

In some implementations, the coordination rules 120 can be stored and/or represented in any form, for example a database table, flat file, binary file, or other suitable file. In some implementations, the coordination rules 120 can be organized to aggregate similar data into groups, for example preferred solution providers, for any suitable reason, such as efficiency, storage reduction, and the like. In some implementations, the coordination rules 120 may be extrapolated based on patterns or trends detected in existing coordination rules 120 at any particular point in time. In some implementations, the coordination rules 120 can be modified by the SPS 102, client 140, and/or other suitable component of the example distributed computing system 102. In some implementations, the coordination rules 120 may also be used to store historical coordination rule 120 information pertaining to the solution provider, solution partners, and/or buyers.

While coordination rules 120 are illustrated as an integral component of the memory 106, in alternative implementations, coordination rules 120 can be external to the memory 106, SPS 102, and/or the example distributed computing system 100 as long as it is accessible using network 130. In some implementations, the coordination rules 120 can act as a reference to an external storage location and/or provide functionality to retrieve coordination rules stored in the external storage location.

The content provider manager 107 is any type of application that allows the client 140 to request and view content on the client 140 after obtaining content from the SPS 102 and/or a content provider (not illustrated) in response to a received request from the client 140. A content provider may be, for example, applications and data on the SPS 102 and/or external services, business applications, business application servers, databases, RSS feeds, document servers, web servers, streaming servers, caching servers, or other suitable content sources. In some implementations, the content provider manager 107 enables the consumption of content provider content by client 140. In some implementations, the content provider manager 107 allows connections to various content providers, queries the content provider with regards to provided content, and enables a user to view, add, edit, and/or delete content associated with the SPS 102. In some implementations, the content provider manager 107 can access and/or modify the software repository 114, recommendation data 116, recommendation rules 118, and or coordination rules 120.

In some implementations, the content provider manager 107 can use display rules 122, and/or other above-described data/rules stored in memory 106, for example the software repository 114, recommendation data 116, recommendation rules 118, and/or coordination rules 120 to perform tasks associated with the SPS 102 or interface with and/or assist any other components of the example distributed computing system 100. For example, in some implementations, the content provider manager 107 can interface with and/or assist one or more of the buying center engine 108, configuration engine 109, and/or GRE 111/PRE 111. Display rules 122 may represent policies, conditions, parameters, variables, algorithms, instructions, constraints, references, and any other appropriate information used by the content provider manager 107 to determine whether to display a GRE recommendation, a GRE and PRE recommendation, or a PRE recommendation. In some implementations, the display rules 122 can also be used by the buying center engine 108, configuration engine 109, and/or the GRE 110/PRE 111, in conjunction with or apart from the content provider manager 107, to determine whether to display a GRE recommendation, a GRE and PRE recommendation, or a PRE recommendation.

In some implementations, the content provider manager 107 can also use content provider manager data (not illustrated) including content provider locations, addresses, storage specifications, content lists, access requirements, or other suitable data. For example, for a database content provider, the content provider manager data may include the server Internet Protocol (IP) address, URL, access permission requirements, data download speed specifications, etc. associated with the database content provider.

Once a particular content provider manager 107 is launched, a client 140 may interactively process a task, event, or other information associated with the SPS 102. The content provider manager 107 can be any application, program, module, process, or other software that may execute, change, delete, generate, or otherwise manage information associated with a particular client 140. For example, the content provider manager 107 may be a portal application, a business application, and/or other suitable application consistent with this disclosure. Additionally, a particular content provider manager 107 may operate in response to and in connection with at least one request received from other content provider managers 107, including a content provider manager 107 associated with another SPS 102. In some implementations, the content provider manager 107 can be and/or include a web browser. In some implementations, each content provider manager 107 can represent a network-based application accessed and executed using the network 130 (e.g., through the Internet, or using at least one cloud-based service associated with the content provider manager 107). For example, a portion of a particular content provider manager 107 may be a web service associated with the content provider manager 107 that is remotely called, while another portion of the content provider manager 107 may be an interface object or agent bundled for processing at a remote client 140. Moreover, any or all of a particular content provider manager 107 may be a child or sub-module of another software module or enterprise application (not illustrated) without departing from the scope of this disclosure. Still further, portions of the particular content provider manager 107 may be executed or accessed by a user working directly at the SPS 102, as well as remotely at a corresponding client 140. In some implementations, the SPS 102 can execute the content provider manager 107.

The buying center engine 108 can be any application, program, module, process, or other software to provide a buying center store and suitable functions to users of the SPS 102. The buying center engine can also provide a GUI environment to control login to/logout from the buying center store as well as various GUI interfaces to provide searching, software application/software application option selection, software application configuration, checkout, software application/software application option download functionality, and/or other suitable operations either independently or in conjunction with the content manager provider 107, configuration engine 109, and/or GRE 111/PRE 111. In some implementations, the buying center engine 108 can also access and/or modify the software repository 114, recommendation data 116, recommendation rules 118, coordination rules 120, and/or display rules 122.

A particular buying center engine 108 may operate in response to and in connection with at least one request received from other buying center engines 108, including a buying center engine 108 associated with another SPS 102. In some implementations, the buying center engine 108 can include a web browser. In some implementations, each buying center engine 108 can represent a network-based application accessed and executed using the network 130 (e.g., through the Internet, or using at least one cloud-based service associated with the buying center engine 108). For example, a portion of a particular buying center engine 108 may be a web service associated with the buying center engine 108 that is remotely called, while another portion of the buying center engine 108 may be an interface object or agent bundled for processing at a remote client 140. Moreover, any or all of a particular buying center engine 108 may be a child or sub-module of another software module or enterprise application (not illustrated) without departing from the scope of this disclosure. Still further, all or portions of the particular buying center engine 108 may be executed or accessed by a user working directly at the SPS 102, as well as remotely at a corresponding client 140.

The configuration engine 109 can be any application, program, module, process, or other software to provide software application configuration functionality for a buying center store. The configuration engine 109 can also provide a GUI environment to provide software application configuration functionality as well as related functionality. In some implementations, the configuration engine 109 can operate either independently or in conjunction with the content manager provider 107, buying center engine 108, and/or GRE 111/PRE 111. In some implementations, the configuration engine 109 can determine either wholly or in part, whether a GRE recommendation, GRE and PRE recommendation, or a PRE recommendation should be displayed. In these instances the configuration engine 109 and/or other suitable components of the example distributed computing system 100 can also use the display rules 122 to help make the determination. In some implementations, the configuration engine 109 can access and/or modify the software repository 114, recommendation data 116, recommendation rules 118, and or coordination rules 120.

In some implementations, the configuration engine 109 can provide custom software application configuration GUI interfaces/wizards to present software application configuration options to buyers depending upon the type of software application selected for configuration. For example, if a buyer selects to configure “Application1,” the presented configuration GUI interfaces and configuration process can be different than the configuration GUI interfaces and configuration process for “Application2.” In some implementations, the configuration engine 109 can also provide custom software application configuration GUI interfaces for the solution provider and/or solution partners displayed to a buyer while configuring a software application. For example, the custom GUI interfaces may be branded to identify the solution provider and/or the solution partners, provide more or less functionality, and the like. The custom GUI interfaces may be offered in conjunction with the configuration engine 109 interfacing with the content provider manager 107, buying center engine 108, and/or GRE 111/PRE 111.

A particular configuration engine 109 may operate in response to and in connection with at least one request received from other configuration engines 109, including a configuration engine 109 associated with another SPS 102. In some implementations, the configuration engine 109 can include a web browser. In some implementations, each configuration engine 109 can represent a network-based application accessed and executed using the network 130 (e.g., through the Internet, or using at least one cloud-based service associated with the configuration engine 109). For example, a portion of a particular configuration engine 109 may be a web service associated with the configuration engine 109 that is remotely called, while another portion of the configuration engine 109 may be an interface object or agent bundled for processing at a remote client 140. Moreover, any or all of a particular configuration engine 109 may be a child or sub-module of another software module or enterprise application (not illustrated) without departing from the scope of this disclosure. Still further, all or portions of the particular configuration engine 109 may be executed or accessed by a user working directly at the SPS 102, as well as remotely at a corresponding client 140.

The general recommendation engine (GRE) 111/private recommendation engine (PRE) 111 can be any application, program, module, process, or other software to provide software application/software application option recommendations to buyers. The GRE 111/PRE 111 are typically the same type of application, but either developed/maintained by either the solution provider/solution partner, respectively. In some implementations, the solution provider can mandate that the PRE 111 conforms to a specific technology, software language, interface design, more or less functionality than the GRE 110, etc. In some implementations, the solution provider can mandate that the PRE 111 must be hosted by the SPS 102. In other implementations, the PRE 111 (and possible associated private software repository 114, recommendation data 116, and recommendation rules 118) can be hosted on an external system to the SPS 10s and accessed/called from the SPS 102 and/or client 140. Although the PRE 111 is shown as a separate module compared to the GRE 110, in some implementations, the PRE 111 can be integral to the GRE 110 or vice versa.

The GRE 111/PRE 111 can provide a GUI environment to provide software application configuration recommendations as well as related functionality. In some implementations, the GRE 111/PRE 111 can operate either independently or in conjunction with the content manager provider 107, buying center engine 108, and/or configuration engine 109. In some implementations, the PRE 111 can operate independently of the GRE 111 and vice-versa.

In some implementations, the GRE 111/PRE 111 can access and/or modify the software repository 114, recommendation data 116, recommendation rules 118, and or coordination rules 120. The GRE 111/PRE 111 can access/modify the software repository 114 to ascertain available software applications/software application options to present to a buyer. The recommendation data 116 and/or recommendation rules 118 provide the GRE 111/PRE 111 data/rules to use to determine appropriate recommendations for the buyer.

For example, in keeping with the example above with XYZ Corp., XYZ Corp. logs into the buying center store to search for accounting software. The GRE 111 determines using the recommendation data 116 that XYZ Corp. is has been using version 2.2 of MediaConversionPlus for eighteen months. A recommendation rule 118 could state that following twelve months following purchase, the buying center store is free to recommend an upgrade of MediaConversionPlus to XYZ Corp. The GRE 111 would then display a GUI interface, a dialog, wizard, or the like, informing the buyer that a later version of the software application is available and recommending that the buyer upgrade their existing version. The buyer has an option to accept or disregard this recommendation.

In conjunction with this, a PRE 111 has also been monitoring the buyer's search/transactions. Using recommendation data 116 and recommendation rules 118 (and/or private versions of the same stored on and/or externally to the SPS 102) the PRE 111 determines that additional software application configuration options that might interest the buyer are available for both the current version of MediaConversionPlus and the upgraded version recommended by GRE 111. The PRE 111 accesses the coordination rules 120 to determine whether it is permitted to recommend the additional software application configuration options to the buyer. In one case, the coordination rules 120 permit a simultaneous recommendation by the PRE 111 only for the older version of MediaConversionPlus. The PRE 111 then triggers a recommendation to the buyer to save money by upgrading software application configuration options in the older version of MediaConversionPlus as opposed to upgrading the MediaConversionPlus software application. In some implementations, the additional recommendation could be made in the GRE 111's GUI interface and/or in a separate GUI interface displayed in parallel with the GRE 111's recommendation GUI. In another case, the coordination rules 120 permit the PRE 111 to make recommendations for software application configuration options for both the older and newer versions of the software application. In still another case, the coordination rules 120 give precedence to the PRE 111 to make the software application upgrade recommendation as well as a recommendation for additional software application configuration options for both the older and never software application versions (i.e., the GRE 111 does not make a recommendation and instead permits the PRE 111 to make recommendations). As will be appreciated by those skilled in the art, these examples are merely representative of a myriad of possible configuration options consistent with this disclosure and are not meant to be limiting in any way.

A particular GRE 111/PRE 111 may operate in response to and in connection with at least one request received from other GREs 110/PREs 1101, including a GRE 111/PRE 111 associated with another SPS 102. In some implementations, the GRE 111/PRE 111 can include a web browser. In some implementations, each GRE 111/PRE 111 can represent a network-based application accessed and executed using the network 130 (e.g., through the Internet, or using at least one cloud-based service associated with the GRE 111/PRE 111). For example, a portion of a particular GRE 111/PRE 111 may be a web service associated with the GRE 111/PRE 111 that is remotely called, while another portion of the GRE 111/PRE 111 may be an interface object or agent bundled for processing at a remote client 140. Moreover, any or all of a particular GRE 111/PRE 111 may be a child or sub-module of another software module or enterprise application (not illustrated) without departing from the scope of this disclosure. Still further, all or portions of the particular GRE 111/PRE 111 may be executed or accessed by a user working directly at the SPS 102, as well as remotely at a corresponding client 140.

In some implementations, the components of the example distributed computing environment 100 can also support one or more clustering environments. For example, the content manager provider 107, buying center engine 108, configuration engine 109, and/or GRE 111/PRE 111 can coordinate the use of the software repository 114, the recommendation data 116, the recommendation rules 118, and/or the coordination rules 120 across multiple SPSs 102 to allow software application configuration and other buying center options.

The client 140 may be any computing device operable to connect to or communicate with at least the SPS 102 using the network 130. In general, the client 140 comprises an electronic computing device operable to receive, transmit, process, and store any appropriate data associated with the example distributed computing system 100. The client includes a processor 144, a client application 146, a plug-in 147, a memory 148, and/or an interface 148.

The client 140 may be used by and represent one or more of a solution provider, a solution partner, or a buyer interfacing with the SPS 102 in various roles. For example, the solution provider can use the client 140 to update recommendation rules 118 while the solution partner can use the client 140 to upload updated configuration data 116 and/or a PRE 111 to the SPS 102. In another example, the buyer can use the client 140 to interface with the SPS 102 to select a software application from the software depository 114 and to configure the software application using the configuration engine 109.

The client application 146 is any type of application that allows the client 140 to navigate to/from, request, view, edit, delete, and or manipulate content on the client 140. In some implementations, the client application 146 can be and/or include a web browser. In some implementations, the client-application 146 can use parameters, metadata, and other information received at launch to access a particular set of data from the SPS 102. Once a particular client application 146 is launched, a user may interactively process a task, event, or other information associated with the SPS 102. Further, although illustrated as a single client application 146, the client application 146 may be implemented as multiple client applications in the client 140. In some implementations, the client application 146 may act as a GUI interface for the content provider manager 107 and/or other components of SPS 102 and/or other components of the example distributed computing environment 100.

The interface 149 is used by the client 140 for communicating with other computing systems in a distributed computing system environment, including within the example distributed computing system 100, using network 130. For example, the client 140 uses the interface to communicate with the SPS 102 as well as other systems (not illustrated) that are communicably coupled to the network 130. The interface 149 may be consistent with the above-described interface 104 of the enterprise server 102 or other interfaces within the example distributed computing system 100. The processor 144 may be consistent with the above-described processor 105 of the SPS 102 or other processors within the example distributed computing system 100. Specifically, the processor 144 executes instructions and manipulates data to perform the operations of the client 140, including the functionality required to send requests to the SPS 102 and to receive and process responses from the SPS 102. The memory 148 may be consistent with the above-described memory 106 of the SPS 102 or other memories within the example distributed computing system 100 but storing objects and/or data associated with the purposes of the client 140, including a software repository, configuration data, recommendation rules, and the like similar to that stored in memory 106 of SPS 102. In some implementations, the memory 148 may be used by SPS 102 to store objects and/or data.

Further, the illustrated client 140 includes a GUI 142. The GUI 142 interfaces with at least a portion of the example distributed computing system 100 for any suitable purpose, including generating a visual representation of a web browser. The GUI 142 may be used to view and navigate various web pages located both internally and externally to the SPS 102. In particular, the GUI 142 may be used to perform functions for providing configuration recommendations as part of a sales process.

There may be any number of clients 140 associated with, or external to, the example distributed computing system 100. For example, while the illustrated example distributed computing system 100 includes one client 140 communicably coupled to the SPS 102 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the SPS 102 or the client 140 itself, including digital data, visual and/or audio information, or a GUI 142, as shown with respect to the client 140.

FIG. 1B is a block diagram 100b illustrating configuration recommendation generation and display as part of a sales process according to one implementation. As illustrated, both the GRE 110 and PRE 111 use recommendation rules 118 and coordination rules 120 as described above according to particular needs, desires, or particular implementations of the example distributed computing system 100. The GRE 110 gets at least internal recommendation data 116 and generates, if permitted, one or more GRE recommendations 150. Similarly, the PRE 111 gets at least external recommendation data 116 and generates, if permitted, one or more PRE recommendations 152. In some implementations, if permitted by the solution provider, the GRE can access the external recommendation data 116 and/or the PRE can access the internal recommendation data 116. In some implementations, if permitted by the solution provider, the GRE can access the recommendation rules 118/coordination rules 120 of the PRE and/or the PRE can access the recommendation rules 110/coordination rules 120 of the GRE.

The content provider manager 107 gets display rules 122 and determines whether to display received GRE/PRE recommendations 150/152 from the GRE 110 and/or PRE 111. For example, the content provider manager 107 may receive multiple recommendations and determine using at least the display rules 122 whether to display a GRE recommendation, a GRE and PRE recommendation, or a PRE recommendation. In some implementations, the buying center engine 108 and/or the configuration engine 109 makes the determination of which recommendation(s) to display in conjunction with the content provider manager 107. In implementations where the buying center engine 108 and/or the configuration engine 109 make the determination as to which recommendation(s) to display, the content provider manager 107 can trigger the display of the recommendation(s) based upon instructions received from the buying center engine 108 and/or the configuration engine 109, from retrieved data, flags, messages, and/or other suitable informational transfer methods. In other implementations, the buying center engine 108 and/or the configuration engine 109 can trigger the display of recommendations independently from the content provider manager 107.

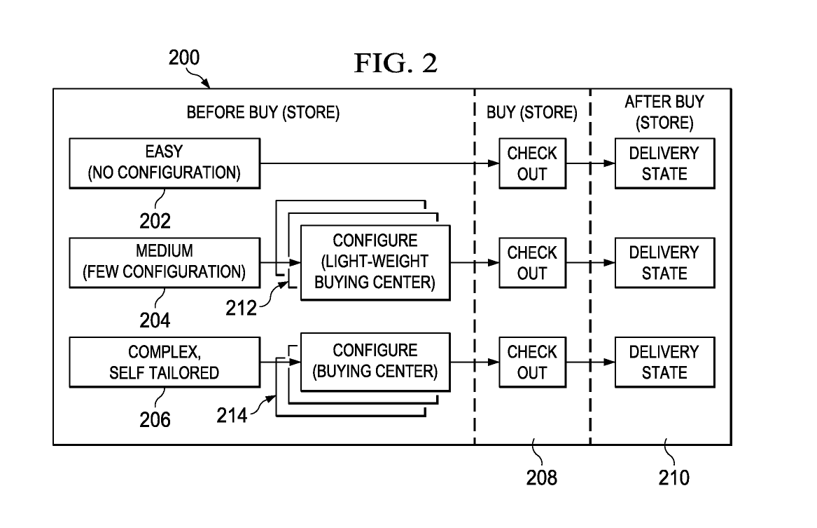

FIG. 2 is a block diagram illustrating different complexity levels of a buying center store 200. For example, a buying center store could include a solution provider “ABC Software,” and solution partners “Custom Solutions, Inc.” and “We Create for You, Corp.” In one embodiment, the buying center store 200 may provide different levels of functionalities with respect to different software applications. FIG. 2 illustrates a buying center store 200 that includes three levels of functionalities: easy level 202, a medium level 204, and a complex level 206. The easy level 202 may be directed to software applications that do not need/have additional configuration options. Buyers may buy this first type of software applications directly from the buying center store 200 solution provider “ABC Software” without any configuration recommendations.

The medium level 204 and complex level 206 of the buying center store 200 is directed to software applications that have medium complexity configuration options available or moderate-to-heavy configuration options available, respectively. For example, in the medium level 204, the buyer may want to buy a software application whose functionalities have only a few available customization options through the removal and/or addition of software application configuration options. The buying center store 200 may then provide basic recommendations of software application configuration options available from the solution provider and/or the solution partners to address determined needs of the buyer based upon at least the recommendation data 116 and/or recommendation rules 118. In the complex level 206, the buying center store 200 may provide more detailed and comprehensive recommendations to address the determined needs of the buyer given the availability of many software application configuration options.

The buying center store 200 may further include an online checkout component 208 through which the buyer may make the purchase transaction of the software application and/or software application configuration options. The checkout component 208 may display the selected software application and/or software application configuration options and blanks for the buyer to select and enter payment information such as credit card information. The checkout component 208 may further include a delivery selection and a confirmation selection. For example, the buyer may select to run the installation directly from the buying center store 200, or to download the installation package to a local machine of the buyer, or to receive a software application package such as a DVD in mail. The buying center store 200 may further include a delivery status component 210 through which a buyer may check whether the purchased software application and/or software application configuration options have been delivered.

The buying center store 200 can be implemented in various configurations without departing from the scope of this disclosure. For example, the buying center store 200 and its various components can be part of an on-demand configuration, a hosted solution, and/or a cloud-computing solution. Other suitable implementation methods, architectures, and/or configurations will be apparent to those skilled in the art.

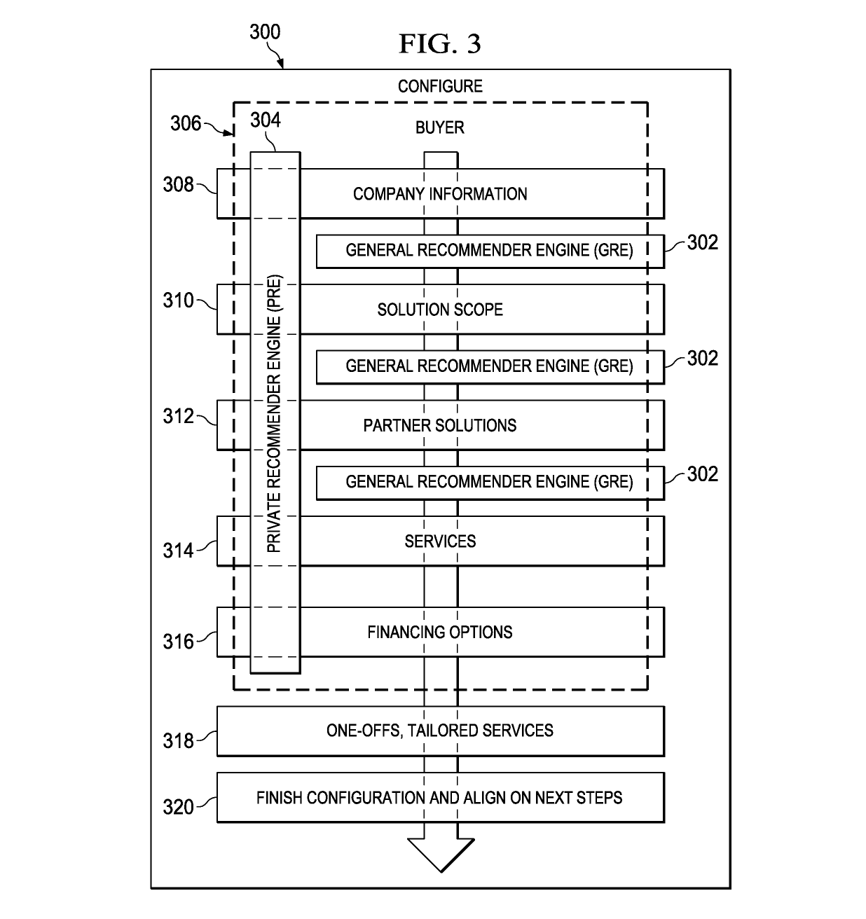

FIG. 3 is a block diagram illustrating scope 300 of general versus private recommendations associated with a buying center store configuration process 212/214. A solution provider's GRE is represented at 302 while a solution partner's PRE is represented at 304. Note that recommendations can be provided by either the GRE/PRE at multiple stages of the configuration process. In this example, a buyer 306 has logged into the buying center store and selected a software application with software configuration options.

In one implementation, company information is accessed by both the GRE 302 and/or PRE 304, most likely within the recommendation data 116 or private recommendation data. Based on the company information, either the GRE 302 and/or the PRE 304 can make a recommendation to the buyer of a software application options generally applicable to the buyer. Note that the PRE 304 may check the coordination rules 120 to determine whether it is permitted to make a recommendation at this point in the configuration process. For example, continuing the XYZ Corp. example above, if the buyer is XYZ Corp., the GRE 302 and/or PRE 304 can make a recommendation to update the version of the MediaConversionPlus software application in use by XYZ Corp. or to purchase a newly available software application providing similar functionality that the GRE 302/PRE 304 has determined to be of interest to XYZ Corp. In some implementations, the GRE 302/PRE 304 can be making parallel recommendations to XYZ Corp., either in a single or multiple GUIs.

Next, the solution scope 310 of interest to the buyer is determined. For example, XYZ Corp. may indicate that they wish to configure the MediaConversionPlus software to support conversion of one video format to another as opposed to any existing configuration option. In this case, the GRE 302/PRE 304 could access the software repository 114, recommender data 116, recommender rules 118, and/or the coordination rules 120 to determine appropriate recommendations for XYZ Corp. for video format conversion functionality options available for the MediaConversionPlus software application. As an example, based upon possible configuration data entered by the buyer, it may be that the GRE 302/PRE 304 would disregard certain video format conversion options as not appropriate for XYZ Corp. and recommend others. For example, if XYZ Corp. wants to convert MPEG-4 to MOV, MKV, or H264 video formats, certain configuration options would be applicable while others would not. XYZ Corp. would then select a recommended configuration option(s) from either the GRE 302/PRE 304 recommendations.

Next, available partner solutions 312 are determined. The GRE 302/PRE 304 each analyze whether the solution provider/solution partner, respectively can offer any specific partner solutions to XYZ Corp. for the selected configuration option(s). If so, the GRE 302/PRE 304 can provide additional recommendations.

Next, services 314 related to the selected configuration option(s) are determined. Note that in this example, the GRE 302 is not applicable as the solution provider does not provide any additional services. Here, the PRE 304 would then make any applicable services recommendations for a selected accounting software application. The remainder of the configuration process with respect to financing options 316 would proceed similar to the services 314 determination with the PRE 304 providing applicable recommendations. In this example, neither the GRE 302 nor PRE 304 are applicable for configuration of “One-offs, tailored services” 318 and “Finish configuration and align on next steps” 320.

In other implementations, the GRE 302 and/or PRE 304 can provide recommendations for all or some stages of the configuration process. Those skilled in the art will appreciate that the availability of the GRE 302/PRE 304 can vary in various implementations of the configuration process, the configuration of the GRE 302/PRE 304, varying company information, solution scope, partner solutions, etc. Additionally, the stages of the configuration process and the type of information used by the GRE 302/PRE 304 can also vary. As such, this example is not meant to be limiting in any way.

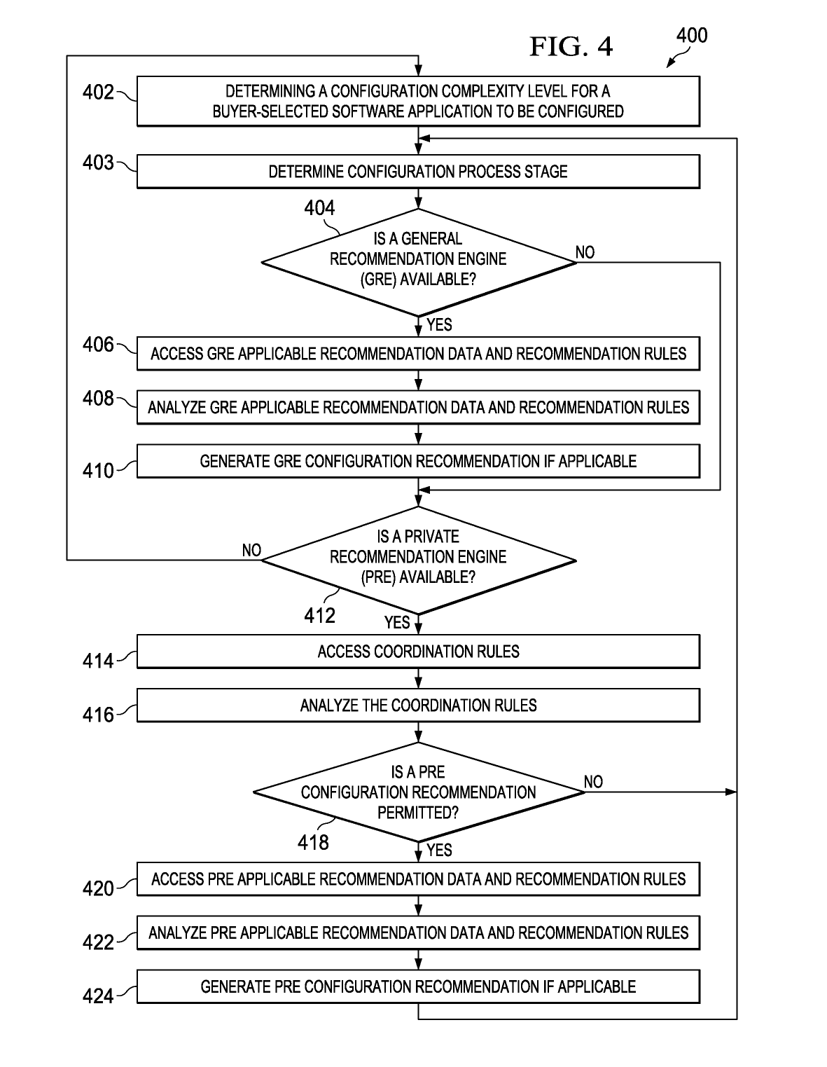

FIG. 4 is a flow chart illustrating a method 400 for providing configuration recommendations as part of a sales process. For clarity of presentation, the description that follows generally describes method 400 in the context of FIGS. 1-3. However, it will be understood that method 400 may be performed, for example, by any other suitable system, environment, software, and hardware, or a combination of systems, environments, software, and hardware as appropriate.

At 402, a configuration complexity level for a buyer-selected software application to be configured is selected. In some implementations, the configuration complexity level is determined from attributes associated with the software application retrieved from the software repository. In some implementations, the configuration complexity level is partially determined based upon attributes associated with the buyer, the buyer's purchase history, configuration history, and the like. From 402, method 400 proceeds to 403.

At 403, a configuration process stage is determined for the configuration sales process. For example, the configuration process stage may include retrieving company information, determining the solution scope, determining partner solutions, or any other suitable configuration process stage. The example configuration sales process and/or configuration process stages provided in FIG. 3 are representative in nature and are not meant to limiting in any way. From 403, method 400 proceeds to 404.

At 404, a determination is made whether a GRE is available. If at 404 it is determined that a GRE is available, method 400 proceeds to 406. If at 404 it is determined that a GRE is not available, method 400 proceeds to 412.

At 406, GRE applicable recommendation data and recommendation rules are accessed. From 406, method 400 proceeds to 408.

At 408, GRE applicable recommendation data and recommendation rules are analyzed. From 408, method 400 proceeds to 410.

At 410, a GRE recommendation is generated if applicable. In some implementations, the complexity of the GRE recommendation is based upon the determined complexity level. From 410, method 400 proceeds to 412.

At 412, a determination is made whether a PRE is available. If at 412 it is determined that a PRE is available, method 400 proceeds to 414. If at 412 it is determined that a PRE is not available, method 400 proceeds to 402.

At 414, coordination rules are accessed. From 414, method 400 proceeds to 416.

At 416, the coordination rules are analyzed. From 416, method 400 proceeds to 418.

At 418, a determination is made whether a PRE recommendation is permitted. If at 418 it is determined that a PRE recommendation is permitted, method 400 proceeds to 420. If at 412 it is determined that a PRE recommendation is not permitted, method 400 proceeds to 402.

At 420, PRE applicable recommendation data and recommendation rules are accessed. From 420, method 400 proceeds to 422.

At 422, PRE applicable recommendation data and recommendation rules are analyzed. From 422, method 400 proceeds to 424.

At 424, a PRE recommendation is generated if applicable. In some implementations, the complexity of the PRE recommendation is based upon the determined complexity level.

Note that in some implementations, the GRE and PRE can run in parallel. In these instances, a coordination rule and/or other suitable rule (not illustrated) can be used to determine if the GRE or PRE takes precedence for generating a recommendation. In some implementations, a GRE/PRE may be used to generate a recommendation if a PRE/GRE, respectively, is otherwise already engaged in generating a recommendation and/or not available. In some implementations, the GRE and PRE may be used to generate a joint recommendation.

Following each generated GRE configuration recommendation and/or generated PRE configuration recommendation, the buyer can be allowed to select a particular configuration recommendation. This selection action can have many results. For example, in some implementations, the selection action can short-circuit the remainder of method 400 and move the buyer to another aspect of the sales process. In other implementations, the selection action can be saved and modified by potentially subsequent configuration recommendations and/or selections. Other variations and/or capabilities consistent with this disclosure are also possible and the presented examples are not meant to be limiting in any way. From 424, method 400 proceeds to 402.

In some implementations, various steps of method 400 can be run in parallel. For example, the determination of whether there is a GRE/PRE available could be run simultaneously along with associated method steps.

FIGS. 1-4 illustrate and describe various aspects of computer-implemented methods, computer-readable media, and computer systems for providing configuration recommendations as part of a sales process. While the disclosure discusses the configuration recommendations in terms of software application configuration options for a software application, as will be apparent to one of skill in the art, FIGS. 1-4 only represent one of many possible implementations and are not meant to limit in any way providing configuration recommendations as part of a sales process to only software applications and/or software application configuration options. The described computer-implemented methods, computer-readable media, and computer systems can also be used to make configuration recommendations for other various products, good, and/or services.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
determining that a general recommendation engine (GRE) is available to make a GRE configuration recommendation for a selected software application;
generating, by operation of a computer, the GRE configuration recommendation for the selected software application based upon GRE-applicable recommendation data and recommendation rules;
determining that a private recommendation engine (PRE) is available to make a PRE configuration recommendation for the selected software application;
determining that the PRE is permitted to make the PRE configuration recommendation based upon analyzed coordination rules; and
generating, by operation of a computer, the PRE configuration recommendation for the selected software application based upon PRE-applicable recommendation data and recommendation rules.

2. The method of claim 1, wherein the software application is selected by a buyer to be configured with respect to optional software application configuration options.

3. The method of claim 2, further comprising determining a configuration complexity level for the software application.

4. The method of claim 3, wherein at least one of a GRE recommendation complexity or a PRE recommendation complexity is based upon the configuration complexity level.

5. The method of claim 1, further comprising determining a configuration process stage associated with a configuration sales process associated with the selected software application.

6. The method of claim 1, further comprising:
accessing the GRE-applicable recommendation data and recommendation rules; and
analyzing the GRE-applicable recommendation data and recommendation rules.

7. The method of claim 1, further comprising:
accessing the coordination rules; and
analyzing the coordination rules.

8. The method of claim 1, further comprising:
accessing the PRE-applicable recommendation data and recommendation rules; and
analyzing the PRE-applicable recommendation data and recommendation rules.

9. A non-transitory, computer-readable medium storing computer-readable instructions executable by a computer to:
determine that a general recommendation engine (GRE) is available to make a GRE configuration recommendation for a selected software application;
generate the GRE configuration recommendation for the selected software application based upon GRE-applicable recommendation data and recommendation rules;
determine that a private recommendation engine (PRE) is available to make a PRE configuration recommendation for the selected software application;
determine that the PRE is permitted to make the PRE configuration recommendation based upon analyzed coordination rules; and
generate the PRE configuration recommendation for the selected software application based upon PRE-applicable recommendation data and recommendation rules.

10. The medium of claim 9, wherein the software application is selected by a buyer to be configured with respect to optional software application configuration options.

11. The medium of claim 10, further comprising instructions to determine a configuration complexity level for the software application.

12. The medium of claim 11, wherein at least one of a GRE recommendation complexity or a PRE recommendation complexity is based upon the configuration complexity level.

13. The medium of claim 9, further comprising instructions to determine a configuration process stage associated with a configuration sales process associated with the selected software application.

14. The medium of claim 9, further comprising instructions to:
access the GRE-applicable recommendation data and recommendation rules; and
analyze the GRE-applicable recommendation data and recommendation rules.

15. The medium of claim 9, further comprising instructions to:
access the coordination rules; and
analyze the coordination rules.

16. The medium of claim 9, further comprising instructions to:
access the PRE-applicable recommendation data and recommendation rules; and
analyze the PRE-applicable recommendation data and recommendation rules.

17. A computer system, comprising:
at least one computer configured to:
determine that a general recommendation engine (GRE) is available to make a GRE configuration recommendation for a selected software application;
generate the GRE configuration recommendation for the selected software application based upon GRE-applicable recommendation data and recommendation rules;
determine that a private recommendation engine (PRE) is available to make a PRE configuration recommendation for the selected software application;
determine that the PRE is permitted to make the PRE configuration recommendation based upon analyzed coordination rules; and
generate the PRE configuration recommendation for the selected software application based upon PRE-applicable recommendation data and recommendation rules.

18. The system of claim 17, wherein the software application is selected by a buyer to be configured with respect to optional software application configuration options.

19. The system of claim 18, further configured to determine a configuration complexity level for the software application.

20. The system of claim 19, wherein at least one of a GRE recommendation complexity or a PRE recommendation complexity is based upon the configuration complexity level.

21. The system of claim 17, further configured to determine a configuration process stage associated with a configuration sales process associated with the selected software application.

22. The system of claim 17, further configured to:
access the GRE-applicable recommendation data and recommendation rules; and
analyze the GRE-applicable recommendation data and recommendation rules.

23. The system of claim 17, further configured to:
access the coordination rules; and
analyze the coordination rules.

24. The system of claim 17, further configured to:
access the PRE-applicable recommendation data and recommendation rules; and
analyze the PRE-applicable recommendation data and recommendation rules.
